(19) United States
(12) Patent Application Publication
(10) Pub. No.: US 2025/0209698 A1
(43) Pub. Date: Jun. 26, 2025

(54) VIDEO EDITING METHOD AND APPARATUS, DEVICE, AND STORAGE MEDIUM

(71) Applicant: Lemon Inc., Grand Cayman (KY)

(72) Inventors: Jingjing Zhuge, Beijing (CN); Yong Yu, Los Angeles, CA (US); Qiang Zhou, Beijing (CN); Lexin Tang, Los Angeles, CA (US)

(21) Appl. No.: 18/848,481

(22) PCT Filed: Mar. 7, 2023
(86) PCT No.: PCT/SG2023/050137

§ 371 Date: Sep. 18, 2024

(30) Foreign Application Priority Data
Mar. 18, 2022 (CN) 202210278993.3

(51) Int. Cl. G06T 11/60

(52) U.S. Cl. CPC G06T 11/60; G06T 2200/24

(57) ABSTRACT

Embodiments of the present application disclose a method, apparatus, device and storage medium of video editing. The method comprises: determining a single-frame processing policy and a video post-processing policy corresponding to a video editing option selected by a user; performing a single-frame processing on video frames of a target video input by the user based on the single-frame processing policy, and caching a single-frame processing result to a single-frame processing list; and forming a video editing sequence of the target video based on the video post-processing policy in combination with the single-frame processing list, and storing the video editing sequence.

This application claims priority to Chinese Application No. 202210278993.3 filed with the Chinese Patent office on Mar. 18, 2022, the disclosures of which are incorporated herein by reference in their entireties.

### FIELD

Embodiments of the present application relate to the technical field of multimedia, e.g., to a method, apparatus, device and storage medium of video editing.

### BACKGROUND

With the rise of short videos and other multimedia functional applications, there is a growing demand for video creation, and video creators gradually spread from professionals to the general public. Video editing is an approach of video creation, and with corresponding editors or editing plug-ins, videos can be edited and processed, so as to obtain video files that better meet user needs.

Most of existing video editing implementations rely on video editors. However, such video editors require human involvement throughout the entire editing process. Thus, their operability has certain technical requirements for users, and they are difficult to master, which is not conducive to popularizing video editing. With the improvement of video editing functions, there also emerges some intelligent video editing software. After a user selects a time node for video editing as well as the desired editing effect, the video editing can be automatically completed at the time node by invoking a video editing algorithm.

However, for this type of video editing algorithm, the algorithmic inference can be hardly completed using the conventional single-frame processing mode, a plurality of frames of image data need to be cached or pre-processing results of a plurality of consecutive frames need to be linked as an edition basis for video editing. When users switch back and forth between time nodes for video editing, they need to re-invoke the video editing algorithm at the time node after the switch to edit video frames at the corresponding time node, which results in a waste of computing resources. Furthermore, in implementations of intelligent video editing, types of feasible video editing are restricted, and some video effects that users expect (e.g., the freezing effect that a post-video frame is frozen in a pre-video frame) cannot be directly achieved by intelligent video editing.

### SUMMARY

The embodiments of the present application provide a method, apparatus, device and storage medium of video editing, which reduce the operation difficulty of video editing and meanwhile save computing resources occupied by video editing.

The embodiments of the present application provide a method of video editing, the method comprising: determining a single-frame processing policy and a video post-processing policy corresponding to a video editing option selected by a user; performing a single-frame processing on video frames of a target video input by the user based on the single-frame processing policy, and caching a single-frame processing result to a single-frame processing list; and forming a video editing sequence of the target video based on the video post-processing policy in combination with the single-frame processing list, and storing the video editing sequence.

The embodiments of the present application further provide an apparatus of video editing, the apparatus comprising: an information determining module configured to determine a single-frame processing policy and a video post-processing policy corresponding to a video editing option selected by a user; a single-frame processing module configured to perform a single-frame processing on video frames of a target video input by the user based on the single-frame processing policy and cache a single-frame processing result to a single-frame processing list; and a video editing module configured to form a video editing sequence of the target video based on the video post-processing policy in combination with the single-frame processing list and store the video editing sequence.

The embodiments of the present application further provide an electronic device, the electronic device comprising: at least one processor; a storage unit configured to store at least one computer program which, when executed by the at least one processor, cause the at least one processor to implement the method of video editing provided by an embodiment of the present application.

The embodiments of the present application further provide a computer readable storage medium storing a computer program thereon, wherein the computer program, when executed by a processor, implements the method of video editing provided by any embodiment of the present application.

### BRIEF DESCRIPTION OF THE DRAWINGS

A brief introduction is presented below to the accompanying drawings to be used in describing the embodiments. It is apparent that the accompanying drawings to be introduced are merely drawings of part of embodiments to be described in the present application, rather than all drawings. Those of ordinary skill in the art may further obtain other drawings based on these accompanying drawings without the exercise of any inventive skill.

FIG. 1 shows a schematic flowchart of a method of video editing provided by a first embodiment of the present application;

FIG. 2 shows a schematic flowchart of a method of video editing provided by a second embodiment of the present application;

FIG. 2a shows a flowchart of an example of the method of video editing provided by the second embodiment of the present application;

FIG. 3 shows a structural schematic diagram of an apparatus of video editing provided by a third embodiment of the present application; and

FIG. 4 shows a structural schematic diagram of an electronic device provided by a fourth embodiment of the present application.

### DETAILED DESCRIPTION OF EMBODIMENTS

The embodiments of the present application will be described with reference to the accompanying drawings, in which some embodiments of the present application have been illustrated. However, it should be understood that the present application can be implemented in various manners, and thus should not be construed to be limited to embodiments disclosed herein. On the contrary, those embodiments are provided for the thorough and complete understanding of the present application. It should be understood that the drawings and embodiments of the present application are only used for illustration, rather than limiting the protection scope of the present application.

It should be understood that various steps described in method implementations of the present application may be performed in a different order and/or in parallel. In addition, the method implementations may comprise an additional step and/or omit a step which is shown. The scope of the present application is not limited in this regard.

The term “comprise” and its variants used herein are to be read as open terms that mean “include, but is not limited to.” The term “based on” is to be read as “based at least in part on.” The term “one embodiment” are to be read as “at least one embodiment.” The term “another embodiment” is to be read as “at least one other embodiment.” The term “some embodiments” are to be read as “at least some embodiments.” Other definitions will be presented in the description below.

Note that the concepts “first,” “second” and so on mentioned in the present application are only for differentiating different apparatuses, modules or units rather than limiting the order or mutual dependency of functions performed by these apparatuses, modules or units. Note that the modifications “one” and “a plurality” mentioned in the present application are illustrative rather than limiting, and those skilled in the art should understand that unless otherwise specified, they should be understood as “one or more.”

Names of messages or information interacted between a plurality of apparatuses in the implementations of the present application are merely for the illustration purpose, rather than limiting the scope of these messages or information.

### The First Embodiment

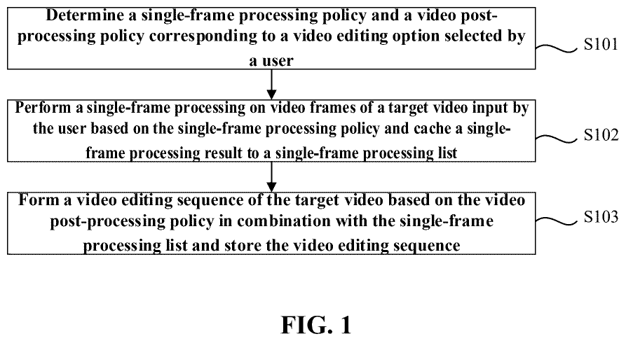

FIG. 1 is a schematic flowchart of a method of video editing provided by a first embodiment of the present application. This embodiment is applicable to secondary editing of videos, wherein the method may be performed by an apparatus of video editing, which may be implemented through software and/or hardware and may be deployed in a terminal and/or server to implement the method of video editing in the embodiments of the present application.

As shown in FIG. 1, a method of video editing provided in this embodiment may comprise the following.

S101, determining a single-frame processing policy and a video post-processing policy corresponding to a video editing option selected by a user.

This embodiment may provide a video editing portal for the user in the form of video editing software or a video editing plugin. The method of video editing in this embodiment may be considered as an implementation of the execution logic of the functional software or plug-in. From a visualization perspective, after the video editing software or plugin triggered by the user enters a functional page, the functional page can present a plurality of video editing options for the user to choose, wherein each video editing option may correspond to one functional implementation of video editing.

It can be learned that the video editing software or plugin presented to the user may contain a plurality of video editing options, different video editing options correspond to different video editing functions, and different video editing effects may be presented after the completion of video editing. Optionally, in a real application scenario, the video editing option may be a video intelligent cutting, for example, completing the intelligent cutting of the input video to obtain a cut video that better meets the user's needs. The video editing option may also be a video screen freezing, for example, regarding the input video, a post-video frame may be frozen in an online video frame through video editing. In addition, the video editing option may further be other functional option that meets the user's editing needs.

Continuing the above description, when the user triggers a video editing option, it may be considered that the user selects a video editing function with the desired video editing effects. At this step, after receiving the video editing option selected by the user, a processing policy corresponding to the video editing option may be found in a plurality of preset editing processing policies, and the corresponding processing policy may comprise a single-frame processing policy for single-frame processing and a video post-processing policy required for video editing.

It is noteworthy that the plurality of editing processing policies may be considered as video editing processing algorithms which are designed in advance for each video editing option to be presented during the development stage of the video editing software or plug-in. During the development stage, a different video editing processing algorithm is equivalent to being set for each video editing option, depending on the video editing purpose or editing effects corresponding to the plurality of video editing options. And at the level of execution logic, this embodiment may collectively refer to the video editing processing algorithms corresponding to each video editing option as an editing processing policy, and the video editing processing algorithms designed relative to the plurality of video editing options at the development stage are also stored as relevant files in the execution device when installing the video editing software or plugin.

Considering the special feature of video editing (e.g., the editing of a preceding video frame needs to use the processing result of a following video frame), the video editing processing algorithms corresponding to the video editing options may be divided into a collection of algorithms based on the processing function. If the video editing processing algorithms for a video editing option comprise a single-frame processing algorithm for single video frame processing and a video post-processing algorithm for video editing, then at the level of execution logic, there exist a corresponding single-frame processing policy and a video post-processing policy. The post-video processing is relative to single-frame processing, which needs to be performed after single-frame processing. Thus, the video editing processing after single-frame processing may be referred to as post-video processing.

S102, performing a single-frame processing on video frames of a target video input by the user based on the single-frame processing policy, and caching a single-frame processing result to a single-frame processing list.

In this embodiment, after determining the single-frame processing policy and the post-video processing policy corresponding to the video editing option selected by the user, this step may perform a single-frame processing on video frames of a target video input by the user based on the single-frame processing policy and cache a single-frame processing result to a single-frame processing list.

In this embodiment, from a visualization perspective, after the user selects a video editing option, a video importing window may pop up, the user may select a video to be edited in the video importing window, and the video to be edited may be referred to as a target video.

After the user selects the target video and initiates a video importing operation, a single-frame processing policy may be performed while importing the target video, i.e., a video frame that meets single-frame processing may be selected from the imported target video and is subjected to single-frame processing. Whether the input video frame meets single-frame processing is implemented by a single-frame processing judgment logic in the single-frame processing policy. With the single-frame processing judgment logic, it may be determined whether the inputting time point of the input video frame reaches a processing interval duration, or it may be determined whether the input video frame meets the frame format of single-frame processing.

The single-frame processing on the video frame may differ depending on different processing needs. For example, the performed processing may be extracting a feature of the video frame, determining a key point in the video frame or determining a location of a character in the video frame. As an example, the single-frame processing may be implemented through a preset single-frame processing model (which may be a neural network model). for example, the video frame that meets the single-frame processing may be input to the single-frame processing model, and data output by the model may be considered as a single-frame processing result of the video frame.

It may be understood that the single-frame processing on the target video at this step may be performed when the target video starts to be imported, and a single-frame processing result of each video frame is cached to a single-frame processing list as an intermediary result for video editing of the target video.

S103, forming a video editing sequence of the target video based on the video post-processing policy in combination with the single-frame processing list, and storing the video editing sequence.

It is noteworthy that the execution order of S103 in this embodiment is not absolutely after S102, which may be initiated during the execution process of S102. As an example, this step may be initiated when a single-frame processing result (only one single-frame processing result may be cached) has been cached in the single-frame processing list. After this step is initiated, first, an execution timing of video post-processing may be determined through a post-processing judgment logic in the video post-processing policy. As long as a judgment object of the post-processing judgment logic meets the post-processing execution requirements at a time point, this step may perform a video editing processing still based on the processing logic in the post-processing policy in combination with the single-frame processing result in the single-frame processing list.

In this embodiment, the single-frame processing result cached in the single-frame processing list may mainly be used as prerequisite data information for the video editing processing. With the video post-processing policy, first, the single-frame processing list may be judged based on the contained post-processing judgment logic, so as to judge whether the current single-frame processing list meets a subsequent video editing condition. That is, the post-processing judgment logic is equivalent to taking the single-frame processing list as a judgment object, and with the post-processing judgment logic, the number of single-frame processing results cached in the single-frame processing list may be judged, and also the correlation between the cached single-frame processing result and the video to be edited may be judged.

It may be learned that when it is determined that the single-frame processing result in the single-frame processing list meets the subsequent video editing condition, the video frame to be edited may be subjected to video editing. It is noteworthy that the video frame to be edited in this embodiment may be considered as a video frame in the target video, which may be selected during executing the video post-processing policy. There is a timing difference between the selected video frame to be edited and the single-frame video frame involved in the single-frame processing, i.e., the frame sequence number corresponding to the single-frame video frame currently involved in the single-frame processing in the target video is greater than that of the video frame to be edited that is to be subjected to video editing.

As an example, suppose a single-frame processing is currently being performed on the 10^{th} video frame in the target video, at which point single-frame processing results of the single-frame processing on the 1^{st} to 9^{th} video frames in the target video have been cached in the single-frame processing list. After executing the video post-processing policy, the 5^{th} video frame in the target video is selected as a video frame to be edited, and it is judged that the number of the single-frame processing results cached in the single-frame processing list meets the condition for editing the 5^{th} video frame. Thereby, the editing processing on the 5^{th} video frame may be completed in combination with the single-frame processing results corresponding to the 1^{st} to 9^{th} video frames.

This embodiment is not intended to limit a processing algorithm used in the single-frame processing and the video post-processing, and different video editing options may correspond to different processing algorithms. Continuing the foregoing example, a smoothing processing is performed on the single-frame processing results of the 1^{st} to 9^{th} video frame. The smoothing processing may be considered as an algorithm of video editing, and the obtained result of the smoothing processing may be considered as a video frame editing result of video editing of the 5^{th} video frame.

This embodiment may realize the video editing of at least one video frame in the target video based on the video post-processing policy, and optionally may complete the video editing of all video frames in the target video. After completing the video editing of at least one video frame to be edited, this step may perform serializing processing on at least one video frame editing result so as to form and store a video editing sequence.

It may be learned that this embodiment is equivalent to realizing in advance the video editing of the target video at the video importing stage. Thereby, when the user enters an editing state to determine a time start node of the target video to be edited, a video frame corresponding to the time start node may be directly located, and a video frame editing result corresponding to the video frame may be obtained based on the video editing sequence. It can be seen that under the editing state, this embodiment can directly obtain the corresponding video frame editing result without the need of re-invoking a video editing algorithm for a video frame.

In the method of video editing provided by the first embodiment, the logic that performs video editing corresponds to an editing processing framework as a whole. A processing policy is preset relative to a user-operable video editing option, and later in the process of the user inputting the target video to be edited, the editing of the whole target video is automatically completed under the video editing operation based on the set processing policy. This is equivalent to that before the user enters an editing state for manual operation, the editing of the whole video is completed in advance, and an editing result is saved. Compared to the existing real-time invocation of algorithms to edit videos in the editing state, this embodiment avoids repeated invocation of video editing algorithms in video editing and saves the occupation of computational resources for video editing. Meanwhile, compared to existing video editing, this embodiment guarantees the intelligent realization of video editing, thereby expanding the application scope of video editing. Furthermore, the execution logic of this embodiment also expands the type of feasible video editors, enabling more user-expected video effects to be realized through intelligent video editing.

As an optional embodiment of this embodiment, on the basis of the foregoing embodiment, further comprises: locating a video frame editing result corresponding to a target video frame based on the video editing sequence, and presenting an edited video, the target video frame being any video frame selected by the user from the target video within an editing interface.

In this optional embodiment, after importing the video, a video frame editing result is provided for any video frame selected by the user under the editing mode with the video frame sequence formed above, and a video which has been edited may be presented after the video frame editing result is provided.

From a visualization perspective, after the uploading of the target video selected by the user is completed, this embodiment may present a video editing interface within a corresponding functional interface, and under the editing interface, a plurality of video frames may be presented in frame units in the order of playback time. The user may drag an editing operation bar within the editing interface through a signal input device such as a mouse and a touchscreen, so as to select a start video frame to be edited. The video start frame may be used as the first target video frame, and subsequent video frames to the video start frame may be used as target video frames.

In this optional embodiment, locating the video frame editing result corresponding to the target video frame based on the video editing sequence and presenting the edited video may comprise:
a) monitoring a drag and drop operation of the user against a target video progress bar, determining a video timestamp corresponding to an end of the drag and drop operation.

The target video progress bar may be considered as an editing operation bar presented within the editing interface while the plurality of video frames of the target video are presented, after importing the target video. The user may drag and drop the target video progress bar and locate a user-desired start point of video editing through drag and drop. This step may monitor a video timestamp corresponding to an end of the drag and drop in the target video.
b) determining a video frame corresponding to the video timestamp as the target video frame and accessing the video editing sequence.

This step can determine a video frame which the above video timestamp points to in the target video, and record the video frame as the target video frame. This step may further access the video editing sequence which has been locally stored relative to the target video.
c) deserializing the video editing sequence to obtain a video frame editing result in the video editing sequence, and locating the target video editing result of the target video frame, and playing the edited video with a time node corresponding to the target video frame as a start playing node.

Through this step, a deserializing operation may be performed on the accessed video editing sequence to obtain at least one video frame editing result arranged in the playback order. This step may directly find the target video editing result corresponding to the target video frame from the obtained video frame editing result, or determine a video frame editing result associated with the target video frame from the obtained video frame editing result and determine the target video editing result of the target video frame based on the associated video frame editing result.

In this optional embodiment, after receiving the target video frame selected by the user under the editing interface, a video frame editing result corresponding to the target video frame may be directly found from the video editing sequence, or the video frame editing result corresponding to the target video frame may be obtained based on the secondary processing of a relevant video frame editing result in the video editing sequence. As an example, when the target video frame is the 10^{th} video frame of the target video and there exist video frame editing results of the 1^{st} to 9^{th} video frames and the 11^{th} to 15^{th} video frames in the video editing sequence, it may be considered that the video frame editing result of the 10^{th} video frame is associated with video frame editing results of the previous 5 frames and the following 5 frames. Thereby, a processing, e.g., secondary smoothing processing may be performed on the video frame editing results of the associated 10 frames, to obtain the video frame editing result of the 10^{th} video frame.

It may be learned that in this embodiment, the target video frame selected when the user ends the drag and drop operation may be considered as a start video frame of video editing, and a time node corresponding to the target video frame may be used as a start playing node; after determining the video frame editing result of the target video frame, this embodiment may continue to determine a video frame editing result for a video frame after the start playing node, and may play each determined video frame editing result. It is noteworthy that each video frame after the start playing node may be re-used as a target video frame to determine a corresponding video frame editing result using the above method in this embodiment.

The above optional embodiment offers a logical implementation of, when the user is actually editing a video, quickly and efficiently realizing video editing and presenting the edited video based on the video editing sequence determined in advance by this embodiment. It can be seen that compared to the related art that repeatedly invokes video editing algorithms for video editing processing as the user switches the start time node of video editing, this optional embodiment can quickly and efficiently complete video editing through the video editing sequence which has been previously determined, and the entire realization logic avoids repeated invocations of video editing algorithms in video editing and saves the occupation of computational resources of video editing.

### The Second Embodiment

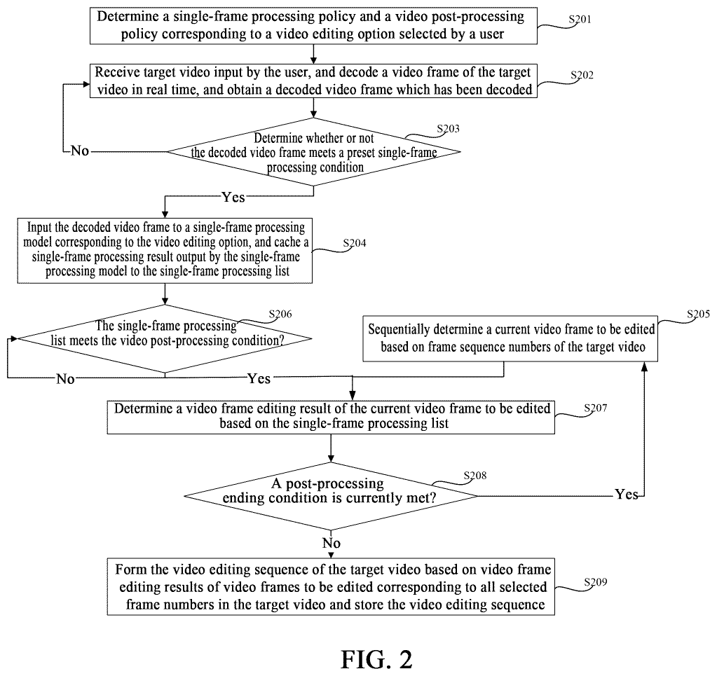

FIG. 2 shows a schematic flowchart of a method of video editing provided by an embodiment of the present application. In this embodiment as the illustration of the above embodiment, performing the single-frame processing on video frames of the target video input by the user based on the single-frame processing policy and caching the single-frame processing result to the single-frame processing list comprises: receiving the target video input by the user, and decoding a video frame of the target video in real time, and obtaining a decoded video frame which has been decoded; in response to that the decoded video frame does not meet a preset single-frame processing condition, returning to obtain a decoded video frame until all decoded video frames are obtained; in response to that the decoded video frame meets the preset single-frame processing condition, inputting the decoded video frame to a single-frame processing model corresponding to the video editing option, and caching the single-frame processing result output by the single-frame processing model to the single-frame processing list; and in the event that the single-frame processing list does not meet a video post-processing condition, returning to obtain a decoded video frame until all decoded video frames are obtained.

Meanwhile, in this embodiment, forming the video editing sequence of the target video based on the video post-processing policy in combination with the single-frame processing list and storing the video editing sequence comprises: sequentially determining a current video frame to be edited based on frame sequence numbers of the target video; in the event of determining that the single-frame processing list currently meets a video post-processing condition, determining a video frame editing result of the current video frame to be edited based on the single-frame processing list; and returning to select a new video frame to be edited for processing, and in the event that a post-processing ending condition is met, forming the video editing sequence of the target video based on video frame editing results of video frames to be edited corresponding to all selected frame numbers in the frame sequence numbers of the target video and storing the video editing sequence.

As shown in FIG. 2, a method of video editing provided by a second embodiment comprises the following:

S201, determining a single-frame processing policy and a video post-processing policy corresponding to a video editing option selected by a user.

As an example, after obtaining a video editing operation selected by a user, a single-frame processing policy and a video post-processing policy corresponding to the video editing option may be matched from preset processing policies.

S202, receiving a target video input by the user, and decoding a video frame of the target video in real time, and obtaining a decoded video frame which has been decoded.

This step is the process of inputting the target video and decoding the input video frame in real time, which will not be repeated here. The decoded video frame can be cached in a decoded video list, and this step may obtain the decoded video frame from the decoded video list.

S203, determining whether or not the decoded video frame meets a preset single-frame processing condition, if not, returning to perform S202; if yes, performing S204.

It should be understood that this step is a subsequent step to S202. After obtaining the decoded video frame, this step may be performed in turn to make a single-frame processing judgment on the decoded video frame. If it is determined that the single-frame processing condition is not met, the flow returns to S202 to re-obtain a new decoded video frame; or when the single-frame processing condition is met, the flow proceeds to S204.

For different video editing options, processing requirements for involvement in single-frame processing might differ, and thus the single-frame processing condition may be set depending on different processing requirements. In this embodiment, the preset single-frame processing condition comprises: a duration of an interval between an obtaining time point for obtaining the decoded video frame and a single-frame executing time point of a previous video frame of a video frame corresponding to the obtaining time point reaches a set duration; or the decoded video frame meets a set frame format. As an example, suppose the interval duration is 1 s, then a time interval between a current frame and a previous video frame for single-frame processing may be determined. If the time interval amounts to 1 s, then it may be considered that the current frame meets the single-frame processing condition; or depending on the video transmission protocol used, the single-frame processing may be performed on only video frames with a keyframe format (the set frame format).

S204, inputting the decoded video frame to a single-frame processing model corresponding to the video editing option, and caching the single-frame processing result output by the single-frame processing model to the single-frame processing list.

This step is equivalent to an execution logic for performing the single-frame processing on the decoded video frame that meets the single-frame processing condition. The single-frame processing model involved in the single-frame processing may be a neural network model that implements a logic, e.g., it may be a network model that positions a character location.

This step may further cache the single-frame processing result output by the single-frame processing model to the single-frame processing list for subsequent video editing of the target video frame.

S205, sequentially determining a current video frame to be edited based on frame sequence numbers of the target video.

This step is a determining step of a video frame to be edited. There is no explicit execution order between this step and the above steps. This step may be initiated in parallel in the process of performing the single-frame processing, or may be performed in turn after completing the single-frame processing on all video frames of the target video that meet the single-frame processing condition.

Optionally, this embodiment is initiated in parallel in the process of performing the single-frame processing. This step, during inputting the target video, may determine a video frame to be edited based on frame sequence numbers of the target video, wherein a start video frame of the target video may be used as the first video frame to be edited, and then a next video frame is sequentially selected as a new video frame to be edited, or a new video frame to be edited may be selected based on a preset selection rule.

S206, judging whether or not the single-frame processing list currently meets a video post-processing condition, and if the single-frame processing list currently does not meet the video post-processing condition, re-performing S206; if yes, performing S207.

It may be learned that whether to start to perform video editing on the video frame to be edited needs to be judged through this step. At the performance time point of this step, if it is determined that the single-frame processing list meets the video post-processing condition, then the following S207 may be performed to determine a video frame editing result of the video frame to be edited based on the single-frame processing result in the single-frame processing list.

If it is determined that the single-frame processing list does not meet the video post-processing condition, then a video post-processing condition judgment needs to be made after re-performing S206 at the performance time point when the judgment is met. It may be learned that this step is equivalent to being performed in parallel during performing the single-frame processing. Therefore, the single-frame processing result in the single-frame processing list is continuously updated. When it is determined that the video post-processing condition is not met, the judgment of S206 may be restarted after a certain duration, or the flow may directly return to make the judgment of S206.

In this embodiment, determining that the single-frame processing list currently meets the video post-processing condition may comprise: the single-frame processing list having cached all associated single-frame processing results required for processing the video frame to be edited. Continuing the example in the first embodiment, suppose the video frame to be edited is the 5^{th} video frame in the target video and the single-frame processing results of the 1^{st} to 9^{th} video frames are required for performing the video editing on the video frame to be edited, then it may be considered that the single-frame processing results of the 1^{st} to 9^{th} video frames are associated single-frame processing results of the 5^{th} video frame. If the single-frame processing list has cached the single-frame processing results of the 1^{st} to 9^{th} video frames at this point, then it may be considered that the video post-processing condition is currently met when performing the judgment at this step.

S207, determining a video frame editing result of the current video frame to be edited based on the single-frame processing list.

In this embodiment, after judging that the single-frame processing list meets the video post-processing condition, a video editing logic in the video post-processing policy may be executed through this step. A video editing may be performed on the video frame to be edited based on a single-frame processing result associated with the video frame to be edited in the single-frame processing list.

This step comprises: obtaining, from the single-frame processing list, all associated single-frame processing results required by the current video frame to be edited; and performing a video frame editing on the current video frame to be edited based on a video editing algorithm corresponding to the video editing option in combination with all associated single-frame processing results required by the current video to be edited.

The video editing algorithm involved in this step may be predesigned and written relative to the video editing option at the programming development stage. this step may directly invoke the pre-written video editing algorithm when executing the video post-processing policy, and the processing object when running the video editing algorithm may be selected as the associated single-frame processing result of the video frame to be edited in the single-frame processing list, and the video frame editing result of the video frame to be edited may be obtained through the algorithmic processing (e.g., smoothing processing between the video frames).

S208, whether or not the post-processing condition is currently met; if not, returning to re-perform S206; if yes, performing S209.

It may be learned that the video post-processing in this embodiment may be cyclic execution logic, and whether to end the cycle may be implemented through the judgment at this step. This step may judge, at the execution time point, whether a post-processing ending condition is met or not; if not, the flow returns to S206 to re-judge whether the post-processing execution condition is met; otherwise it may be considered that the post-processing ending condition is met, and the operation of S209 may be performed subsequently.

Optionally, the post-processing ending condition may comprise: video frame editing results being determined for all video frames with selected frame sequence numbers in the target video. It may be understood that during the execution of the video post-processing, not every video frame needs to be subjected to the video editing as a video frame to be edited, and video frames with selected frame sequence numbers in the target video might be used as video frames to be edited. Thereby, when it is judged that all video frames with selected frame sequence numbers in the target video have been subjected to the video editing with video frame editing results, it may be determined that the video editing of the target video has been currently completed, and the video post-processing may be ended in this embodiment.

S209, forming the video editing sequence of the target video based on video frame editing results of video frames to be edited with all selected frame numbers in the target video and storing the video editing sequence.

It may be learned that all video frame editing results may be obtained after ending the video post-processing of the target video. This step may perform a serialization processing on the obtained video frame editing results, thereby forming the video editing sequence.

This embodiment may form the video editing sequence of the target video based on the video frame editing results, arrange the video frame editing results based on a serialization rule corresponding to the video editing option, obtain the video editing sequence and store the video editing sequence in a nonvolatile manner.

In this embodiment, the serialization processing may be realized based on the serialization rule corresponding to the video editing option, and the final result may be stored to a local disk in a nonvolatile manner.

The method of video editing provided by the second embodiment offers the implementation of the single-frame processing policy and also the implementation of the video post-processing. With the method provided by this embodiment, processing policies are preset relative to the user operable video editing option, and later during the user inputting the target video to be edited, the editing of the whole target video is automatically completed under the video editing option based on the set processing policies. This corresponds to that before the user enters the editing state for manual operation, the editing of the whole video is completed in advance, and the editing result is saved. This method avoids repeated invocations of video editing algorithms in video editing and saves the occupation of computational resources of video editing; meanwhile, the method guarantees the intelligent realization of video editing, thereby expanding the application scope of video editing; furthermore, this method expands the types of feasible video editing, enabling more user-expected video effects to be realized through intelligent video editing.

To facilitate the understanding of the method provided by this embodiment, an example flow is presented below to illustrate the execution process of the method of video editing in real applications:

S1, receiving a video editing option selected by a user.

S2, receiving a target video input by the user in a given uploading window.

S3, decoding the target video to obtain a current decoded video frame.

S4, judging whether or not the decoded video frame meets a single-frame processing condition of the video editing option, and if the decoded video frame meets the single-frame processing condition of the video editing option, then performing S5; if the decoded video frame does not meet the single-frame processing condition of the video editing option, then returning to perform S3.

S5, performing a single-frame processing on the decoded video frame to obtain a single-frame processing result and cache the same to a single-frame processing list.

S6, selecting a current video frame to be edited from the input target video.

S6, S7 and S8 may follow S2 and be synchronously performed after S2.

S7, judging whether or not the current single-frame processing list meets a video post-processing condition, and if the current single-frame processing list meets the video post-processing condition, then performing S8; if the current single-frame processing list does not meet the video post-processing condition, then re-performing S7.

S8, performing a video editing on the video frame to be edited based on the single-frame processing result in the single-frame processing list, to obtain a video frame editing result.

S9, judging whether or not a post-processing ending condition is met, and if the post-processing ending condition is met, then performing S10; if the post-processing ending condition is not met, then returning to perform S6.

S10, obtaining a video editing sequence of the target video based on all video frame editing results determined by a serialization rule.

S11, after presenting the input target video in an editing-state interface, receiving a user drag and drop progress bar to determine a start time node corresponding to the editing of the target video.

In this step, presenting the input target video in the editing-state interface may actually be after obtaining the video editing sequence of the target video.

S12, determining a target video frame in the target video corresponding to the video editing start node.

S13, accessing the video editing sequence, and obtaining a target video editing result of the target video frame based on the video editing sequence.

S14, present an edited target video starting from the target video editing result.

### The Third Embodiment

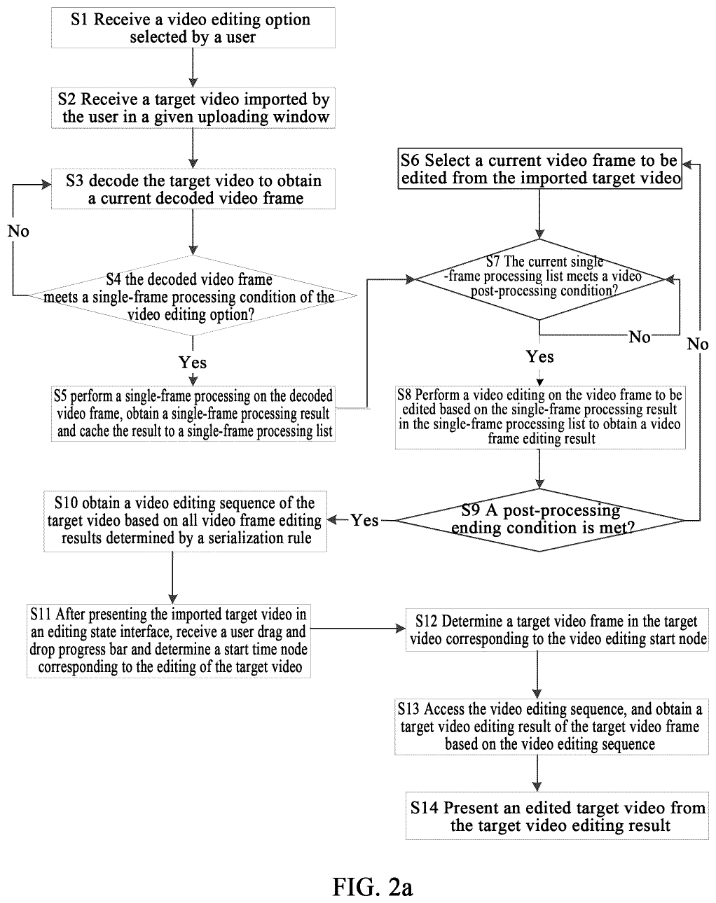

FIG. 3 shows a structural schematic diagram of an apparatus of video editing provided a third embodiment of the present application. This embodiment is applicable to the editing of a video, and the apparatus may be implemented through software and/or hardware and may be deployed in a terminal and/or server to perform the method of video editing in the embodiments of the present application. The apparatus may comprise: an information determining module 31, a single-frame processing module 32 and a video editing module 33.

The information determining module 31 is configured to determine a single-frame processing policy and a video post-processing policy corresponding to a video editing option selected by a user; the single-frame processing module 32 is configured to perform a single-frame processing on video frames of a target video input by the user based on the single-frame processing policy and cache a single-frame processing result to a single-frame processing list; and the video editing module 33 is configured to form a video editing sequence of the target video based on the video post-processing policy in combination with the single-frame processing list and store the video editing sequence.

The apparatus of video editing provided by this embodiment is integrated in an execution device and is equivalent to an editing processing framework as a whole. With the apparatus, processing policies are preset relative to the user operable video editing option, and later during the user inputting the target video to be edited, the editing of the whole target video is automatically completed under the video editing option based on the set processing policies. This is equivalent to that before the user enters the editing state for manual operation, the editing of the whole video is completed in advance, and the editing result is saved. Compared to real-time invocations of algorithms to edit videos in the prior art, the present application avoids repeated invocations of video editing algorithms in video editing and saves the occupation of computational resources of video editing; meanwhile, compared to existing video editing, the present application guarantees the intelligent realization of video editing, thereby expanding the application scope of video editing; furthermore, the execution logic of the present application expands the types of feasible video editing, enabling more user-expected video effects to be realized through intelligent video editing.

On the basis of any optional embodiment of the embodiments of the present application, optionally, the apparatus may further comprise: an edition presenting module configured to locate a video frame editing result corresponding to a target video frame based on the video editing sequence and present an edited video, the target video frame being any video frame selected by the user from the target video within an editing interface.

On the basis of any optional embodiment of the embodiments of the present application, optionally, the edition presenting module may be configured to: monitor a drag and drop operation of the user against a target video progress bar, and determine a video timestamp corresponding to an end of the drag and drop operation; determine a video frame corresponding to the video timestamp as the target video frame and access the video editing sequence; and deserialize the video editing sequence to obtain a video frame editing result in the video editing sequence, and locate the target video editing result of the target video frame, and playing the edited video with a time node corresponding to the target video frame as a start playing node.

On the basis of any optional embodiment of the embodiments of the present application, optionally, the single-frame processing module 32 may be configured to: receive the target video input by the user, and decode a video frame of the target video in real time, and obtaining a decoded video frame which has been decoded; if the decoded video frame does not meet a preset single-frame processing condition, return to obtain a decoded video frame until all decoded video frames are obtained; if the decoded video frame meets the preset single-frame processing condition, input the decoded video frame to a single-frame processing model corresponding to the video editing option, and cache the single-frame processing result output by the single-frame processing model to the single-frame processing list; and in the event that the single-frame processing list does not meet a video post-processing condition, return to obtain a decoded video frame until all decoded video frames are obtained.

The preset single-frame processing condition comprises: a duration of an interval between an obtaining time point for obtaining the decoded video frame and a single-frame executing time point of a previous video frame of a video frame corresponding to the obtaining time point reaches a set duration; or the decoded video frame meets a set frame format.

On the basis of any optional embodiment of the embodiments of the present application, optionally, the video editing module 33 may comprise: an edited frame determining unit configured to sequentially determine a current video frame to be edited based on frame sequence numbers of the target video; an edition performing unit configured to, in the event of determining that the single-frame processing list currently meets a video post-processing condition, determine a video frame editing result of the current video frame to be edited based on the single-frame processing list; and a sequence determining unit configured to return to select a new video frame to be edited for processing, and in the event that a post-processing ending condition is met, form the video editing sequence of the target video based on video frame editing results of video frames to be edited corresponding to all selected frame numbers in the frame sequence numbers of the target video and store the video editing sequence.

On the basis of any optional embodiment of the embodiments of the present application, optionally, the edition performing unit may be configured to: determine that the single-frame processing list currently meets a video post-processing condition in the event that the single-frame processing list has cached all associated single-frame processing results required by the current video frame to be edited; obtain, from the single-frame processing list, all associated single-frame processing results required by the current video frame to be edited; and perform a video frame editing on the current video frame to be edited based on a video editing algorithm corresponding to the video editing option in combination with all associated single-frame processing results required by the current video to be edited.

The post-processing ending condition comprises: video frame editing results being determined for all video frames with selected frame sequence numbers in the target video, wherein a video frame with a selected frame sequence number in the target video is a video frame to be edited.

On the basis of any optional embodiment of the embodiments of the present application, optionally, the sequence determining unit may be configured to: return to select a new video frame to be edited, and in the event that the post-processing ending condition is met, arrange the video frame editing results of the video frames to be edited corresponding to the selected frame sequence numbers based on a serialization rule corresponding to the video editing option, obtain the video editing sequence and store the video editing sequence in a nonvolatile manner.

The video editing option comprises a video intelligent cutting and a video screen freezing.

The above apparatus may perform the method provided by any embodiment of the present application and has corresponding functional modules for performing the method.

It is noteworthy that the plurality of units and modules comprised by the above apparatus are merely divided by functional logic and are not limited to the above division, so long as they can achieve corresponding functions. In addition, names of the plurality of functional units are merely for mutual differentiation, rather than limiting the protection scope of protection of the embodiments of the present application.

### The Fourth Embodiment

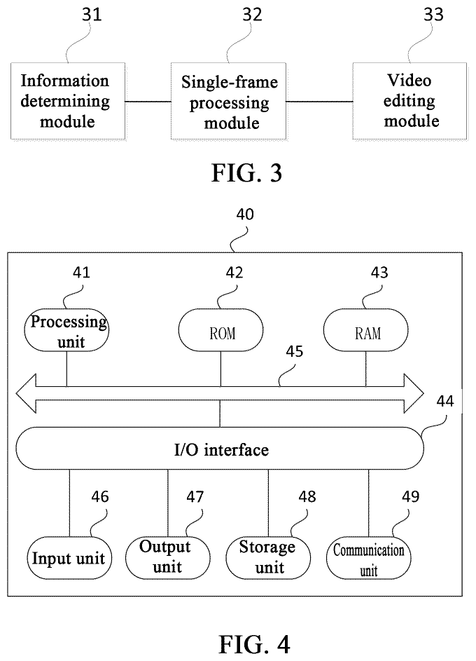

FIG. 4 shows a structural schematic diagram of an electronic device provided by a fourth embodiment of the present application. With reference to FIG. 4, this figure shows a structural schematic diagram of an electronic device (e.g., a terminal device or server in FIG. 4) 40 which is applicable to implement the embodiments of the present disclosure. The terminal device in the embodiments of the present disclosure may include, without limitation to, a mobile terminal such as a mobile phone, a notebook computer, a digital broadcast receiver, a PDA (personal digital assistant), a PAD (portable Android device), a PMP (portable multimedia player), an on-board terminal (e.g., an on-board navigation terminal) and the like, and a fixed terminal such as digital TV, a desktop computer and the like. The electronic device shown in FIG. 4 is merely an example and should not be construed as bringing any restriction on the functionality and usage scope of the embodiments of the present disclosure.

As shown in FIG. 4, the electronic device 40 may comprise a processing unit (e.g., a central processor, a graphics processor) 41 which is capable of performing various appropriate actions and processes in accordance with programs stored in a read only memory (ROM) 42 or programs loaded from a storage unit 48 to a random access memory (RAM) 43. In the RAM 43, there are also stored various programs and data required by the electronic device 400 when operating. The processing unit 41, the ROM 42 and the RAM 43 are connected to one another via a bus 44. An input/output (I/O) interface 45 is also connected to the bus 44.

Usually, the following units may be connected to the I/O interface 45: an input unit 46 including a touch screen, a touch pad, a keyboard, a mouse, a camera, a microphone, an accelerometers, a gyroscope, or the like; an output unit 47, such as a liquid-crystal display (LCD), a loudspeaker, a vibrator, or the like; a storage unit 48, such as a magnetic tape, a hard disk or the like; and a communication unit 49. The communication unit 49 allows the electronic device to perform wireless or wired communication with other device so as to exchange data with other device. While FIG. 4 shows the electronic device with various units, it should be understood that it is not required to implement or have all of the illustrated units. Alternatively, more or less units may be implemented or exist.

Specifically, according to the embodiments of the present disclosure, the procedures described with reference to the flowchart may be implemented as computer software programs. For example, the embodiments of the present disclosure comprise a computer program product that comprises a computer program embodied on a non-transitory computer-readable medium, the computer program including program codes for executing the method shown in the flowchart. In such an embodiment, the computer program may be loaded and installed from a network via the communication unit 49, or installed from the storage unit 48, or installed from the ROM 42. The computer program, when executed by the processing unit 41, perform the above functions defined in the method of the embodiments of the present disclosure.

Names of messages or information interacted between a plurality of apparatuses in the implementations of the present application are merely for the illustration purpose, rather than limiting the scope of these messages or information.

The electronic device provided by the embodiment of the present application and the method of video editing provided by the above embodiments belong to the same inventive concept, and technical details which are not detailed in this embodiment may be referred to the above embodiments.

### The Fifth Embodiment

An embodiment of the present application provides a computer storage medium storing a computer program thereon, which, when executed by a processor, implements the method of video editing provided by the above embodiments of the present application.

It is noteworthy that the computer readable medium of the present disclosure can be a computer readable signal medium, a computer readable storage medium or any combination thereof. The computer readable storage medium may be, for example, but is not limited to, an electronic, magnetic, optical, electromagnetic, infrared or semiconductor system, apparatus or device, or any combination of the foregoing. More specific examples of the computer readable storage medium may include, without limitation to, the following: an electrical connection with one or more conductors, a portable computer diskette, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination of the foregoing.

In the present application, the computer readable storage medium may be any tangible medium containing or storing a program which may be used by an instruction executing system, apparatus or device or used in conjunction therewith. In the present disclosure, the computer readable signal medium may include a data signal propagated in baseband or as part of a carrier wave, with computer readable program code carried therein. The data signal propagated as such may take various forms, including without limitation to, an electromagnetic signal, an optical signal or any suitable combination of the foregoing. The computer readable signal medium may further be any other computer readable medium than the computer readable storage medium, which computer readable signal medium may send, propagate or transmit a program used by an instruction executing system, apparatus or device or used in conjunction with the foregoing. The program code included in the computer readable medium may be transmitted using any suitable medium, including without limitation to, an electrical wire, an optical fiber cable, RF (radio frequency), etc., or any suitable combination of the foregoing.

In some implementations, the client and the server may communicate using any network protocol that is currently known or will be developed in future, such as the hyper text transfer protocol (HTTP) and the like, and may be interconnected with digital data communication (e.g., communication network) in any form or medium. Examples of communication networks include local area networks (LANs), wide area networks (WANs), inter-networks (e.g., the Internet) and end-to-end networks (e.g., ad hoc end-to-end networks), as well as any networks that are currently known or will be developed in future.

The above computer readable medium may be included in the above-mentioned electronic device; and it may also exist alone without being assembled into the electronic device.

The computer readable medium carries one or more programs which, when executed by the electronic device, cause the electronic device to: determine a single-frame processing policy and a video post-processing policy corresponding to a video editing option selected by a user; perform a single-frame processing on video frames of a target video input by the user based on the single-frame processing policy, and cache a single-frame processing result to a single-frame processing list; and form a video editing sequence of the target video based on the video post-processing policy in combination with the single-frame processing list, and store the video editing sequence.

Computer program codes for carrying out operations of the present disclosure may be written in one or more programming languages, including without limitation to, an object oriented programming language such as Java, Smalltalk, C++ or the like, and conventional procedural programming languages, such as the “C” programming language or similar programming languages. The program codes may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The flowchart and block diagrams in the figures illustrate the architecture, functionality, and operation of possible implementations of systems, methods and computer program products according to various implementations of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The units described in the embodiments of the present disclosure may be implemented as software or hardware. The name of a unit does not form any limitation to the unit per se. For example, the first obtaining unit may be described as “a unit configured to obtain at least two Internet Protocol addresses.”

The functions described above may be executed, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc.

In the context of the present disclosure, the machine readable medium may be a tangible medium, which may include or store a program used by an instruction executing system, apparatus or device or used in conjunction with the foregoing. The machine readable medium may be a machine readable signal medium or a machine readable storage medium. The machine readable medium may include, but is not limited to, an electronic, magnetic, optical, electromagnetic, infrared, semiconductor system, means or device, or any suitable combination of the foregoing. More specific examples of the machine readable storage medium include the following: an electric connection with one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

According to one or more embodiments of the present application, a first example provides a method of video editing, the method comprising: determining a single-frame processing policy and a video post-processing policy corresponding to a video editing option selected by a user; performing a single-frame processing on video frames of a target video input by the user based on the single-frame processing policy, and caching a single-frame processing result to a single-frame processing list; and forming a video editing sequence of the target video based on the video post-processing policy in combination with the single-frame processing list, and storing the video editing sequence.

According to one or more embodiments of the present application, a second example provides a method of video editing, the method optionally comprising: locating a video frame editing result corresponding to a target video frame based on the video editing sequence, and presenting an edited video, the target video frame being any video frame selected by the user from the target video within an editing interface.

According to one or more embodiments of the present application, a third example provides a method of video editing, the method comprising: monitoring a drag and drop operation of the user against a target video progress bar, determining a video timestamp corresponding to an end of the drag and drop operation; determining a video frame corresponding to the video timestamp as the target video frame and accessing the video editing sequence; and deserializing the video editing sequence to obtain a video frame editing result in the video editing sequence, and locating the target video editing result of the target video frame, and playing the edited video with a time node corresponding to the target video frame as a start playing node.

According to one or more embodiments of the present application, a fourth example provides a method of video editing, wherein: performing the single-frame processing on video frames of the target video input by the user based on the single-frame processing policy and caching the single-frame processing result to the single-frame processing list optionally comprises: receiving the target video input by the user, and decoding a video frame of the target video in real time, and obtaining a decoded video frame which has been decoded; in response to that the decoded video frame does not meet a preset single-frame processing condition, returning to obtain a decoded video frame until all decoded video frames are obtained; in response to that the decoded video frame meets the preset single-frame processing condition, inputting the decoded video frame to a single-frame processing model corresponding to the video editing option, and caching the single-frame processing result output by the single-frame processing model to the single-frame processing list; and in the event that the single-frame processing list does not meet a video post-processing condition, returning to obtain a decoded video frame until all decoded video frames are obtained.

According to one or more embodiments of the present application, a fifth example provides a method of video editing, wherein the preset single-frame processing condition may comprise: a duration of an interval between an obtaining time point for obtaining the decoded video frame and a single-frame executing time point of a previous video frame of a video frame corresponding to the obtaining time point reaches a set duration; or the decoded video frame meets a set frame format.

According to one or more embodiments of the present application, a sixth example provides a method of video editing, wherein forming the video editing sequence of the target video based on the video post-processing policy in combination with the single-frame processing list and storing the video editing sequence optionally comprises: sequentially determining a current video frame to be edited based on frame sequence numbers of the target video; in the event of determining that the single-frame processing list currently meets a video post-processing condition, determining a video frame editing result of the current video frame to be edited based on the single-frame processing list; and returning to select a new video frame to be edited for processing, and in the event that a post-processing ending condition is met, forming the video editing sequence of the target video based on video frame editing results of video frames to be edited corresponding to all selected frame numbers in the frame sequence numbers of the target video and storing the video editing sequence.

According to one or more embodiments of the present application, a seventh example provides a method of video editing, wherein determining the video frame editing result of the current video frame to be edited based on the single-frame processing list in the event of determining that the single-frame processing list currently meets a video post-processing condition may comprise: determining that the single-frame processing list currently meets a video post-processing condition in the event that the single-frame processing list has cached all associated single-frame processing results required by the current video frame to be edited; obtaining, from the single-frame processing list, all associated single-frame processing results required by the current video frame to be edited; and performing a video frame editing on the current video frame to be edited based on a video editing algorithm corresponding to the video editing option in combination with all associated single-frame processing results required by the current video to be edited.

According to one or more embodiments of the present application, an eighth example provides a method of video editing, wherein the post-processing ending condition may comprise: video frame editing results being determined for all video frames with selected frame sequence numbers in the target video, wherein a video frame with a selected frame sequence number in the target video is a video frame to be edited.

According to one or more embodiments of the present application, a ninth example provides a method of video editing, wherein forming the video editing sequence of the target video based on the video frame editing results of the video frames to be edited corresponding to all selected frame numbers in the frame sequence numbers of the target video and storing the video editing sequence may comprise: arranging the video frame editing results of the video frames to be edited corresponding to the selected frame sequence numbers based on a serialization rule corresponding to the video editing option, and obtaining the video editing sequence and storing the video editing sequence in a nonvolatile manner.

According to one or more embodiments of the present application, a tenth example provides a method of video editing, wherein the video editing option comprises a video intelligent cutting and a video screen freezing.

The foregoing description merely illustrates the preferable embodiments of the present disclosure and used technical principles. Those skilled in the art should understand that the scope of the present disclosure is not limited to technical solutions formed by specific combinations of the foregoing technical features and also cover other technical solution formed by any combinations of the foregoing or equivalent features without departing from the concept of the present disclosure, such as a technical solution formed by replacing the foregoing features with the technical features disclosed in the present disclosure (but not limited to) with similar functions.

In addition, although various operations are depicted in a particular order, this should not be construed as requiring that these operations be performed in the particular order shown or in a sequential order. In a given environment, multitasking and parallel processing may be advantageous. Likewise, although the above discussion contains several specific implementation details, these should not be construed as limitations on the scope of the present disclosure. Certain features that are described in the context of separate embodiments can also be implemented in combination in a single embodiment. Conversely, various features that are described in the context of a single embodiment can also be implemented in multiple embodiments separately or in any suitable subcombination.

1. A video editing method, comprising:
determining a single-frame processing policy and a video post-processing policy corresponding to a video editing option selected by a user;
performing a single-frame processing on video frames of a target video input by the user based on the single-frame processing policy, and caching a single-frame processing result to a single-frame processing list; and
forming a video editing sequence of the target video based on the video post-processing policy in combination with the single-frame processing list, and storing the video editing sequence.

2. The method of claim 1, further comprising:
locating a video frame editing result corresponding to a target video frame based on the video editing sequence, and presenting an edited video, the target video frame being any video frame selected by the user from the target video within an editing interface.

3. The method of claim 2, wherein locating the video frame editing result corresponding to the target video frame based on the video editing sequence and presenting the edited video comprises:
monitoring a drag and drop operation of the user against a target video progress bar, determining a video timestamp corresponding to an end of the drag and drop operation;
determining a video frame corresponding to the video timestamp as the target video frame and accessing the video editing sequence; and
deserializing the video editing sequence to obtain a video frame editing result in the video editing sequence, and locating the target video editing result of the target video frame, and playing the edited video with a time node corresponding to the target video frame as a start playing node.

4. The method of claim 1, wherein performing the single-frame processing on video frames of the target video input by the user based on the single-frame processing policy and caching the single-frame processing result to the single-frame processing list comprises:
receiving the target video input by the user, and decoding a video frame of the target video in real time, and obtaining a decoded video frame which has been decoded;
in response to that the decoded video frame does not meet a preset single-frame processing condition, returning to obtain a decoded video frame until all decoded video frames are obtained;
in response to that the decoded video frame meets the preset single-frame processing condition, inputting the decoded video frame to a single-frame processing model corresponding to the video editing option, and caching the single-frame processing result output by the single-frame processing model to the single-frame processing list; and
in the event that the single-frame processing list does not meet a video post-processing condition, returning to obtain a decoded video frame until all decoded video frames are obtained.

5. The method of claim 4, wherein the preset single-frame processing condition comprises:
a duration of an interval between an obtaining time point for obtaining the decoded video frame and a single-frame executing time point of a previous video frame of a video frame corresponding to the obtaining time point reaches a set duration; or
the decoded video frame meets a set frame format.

6. The method of claim 1, wherein forming the video editing sequence of the target video based on the video post-processing policy in combination with the single-frame processing list and storing the video editing sequence comprises:
sequentially determining a current video frame to be edited based on frame sequence numbers of the target video;
in the event of determining that the single-frame processing list currently meets a video post-processing condition, determining a video frame editing result of the current video frame to be edited based on the single-frame processing list; and
returning to select a new video frame to be edited for processing, and in the event that a post-processing ending condition is met, forming the video editing sequence of the target video based on video frame editing results of video frames to be edited corresponding to all selected frame numbers in the frame sequence numbers of the target video and storing the video editing sequence.

7. The method of claim 6, wherein determining the video frame editing result of the current video frame to be edited based on the single-frame processing list in the event of determining that the single-frame processing list currently meets a video post-processing condition comprises:
determining that the single-frame processing list currently meets a video post-processing condition in the event that the single-frame processing list has cached all associated single-frame processing results required by the current video frame to be edited;
obtaining, from the single-frame processing list, all associated single-frame processing results required by the current video frame to be edited; and
performing a video frame editing on the current video frame to be edited based on a video editing algorithm corresponding to the video editing option in combination with all associated single-frame processing results required by the current video to be edited.

8. The method of claim 6, wherein the post-processing end condition comprises:
video frame editing results being determined for all video frames with selected frame sequence numbers in the target video, wherein a video frame with a selected frame sequence number in the target video is a video frame to be edited.

9. The method of claim 6, wherein forming the video editing sequence of the target video based on the video frame editing results of the video frames to be edited corresponding to all selected frame numbers in the frame sequence numbers of the target video and storing the video editing sequence comprises:
arranging the video frame editing results of the video frames to be edited corresponding to the selected frame sequence numbers based on a serialization rule corresponding to the video editing option, and obtaining the video editing sequence and storing the video editing sequence in a nonvolatile manner.

10. The method of any of claim 1, wherein the video editing option comprises a video intelligent cutting and a video screen freezing.

11. (canceled)

12. An electronic device, comprising:
at least one processor; and
a storage unit configured to store at least one computer program, the at least one computer program, when executed by the at least one processor, causes the at least one processor to implement actions comprising:
determining a single-frame processing policy and a video post-processing policy corresponding to a video editing option selected by a user;
performing a single-frame processing on video frames of a target video input by the user based on the single-frame processing policy, and caching a single-frame processing result to a single-frame processing list; and
forming a video editing sequence of the target video based on the video post-processing policy in combination with the single-frame processing list, and storing the video editing sequence.

13. A non-transitory computer readable storage medium storing a computer program thereon, wherein the computer program, when executed by a processor, implements a video editing method comprising:
determining a single-frame processing policy and a video post-processing policy corresponding to a video editing option selected by a user;
performing a single-frame processing on video frames of a target video input by the user based on the single-frame processing policy, and caching a single-frame processing result to a single-frame processing list; and
forming a video editing sequence of the target video based on the video post-processing policy in combination with the single-frame processing list, and storing the video editing sequence.

14. The electronic device of claim 12, further comprising:
locating a video frame editing result corresponding to a target video frame based on the video editing sequence, and presenting an edited video, the target video frame being any video frame selected by the user from the target video within an editing interface.

15. The electronic device of claim 14, wherein locating the video frame editing result corresponding to the target video frame based on the video editing sequence and presenting the edited video comprises:
monitoring a drag and drop operation of the user against a target video progress bar, determining a video timestamp corresponding to an end of the drag and drop operation;
determining a video frame corresponding to the video timestamp as the target video frame and accessing the video editing sequence; and
deserializing the video editing sequence to obtain a video frame editing result in the video editing sequence, and locating the target video editing result of the target video frame, and playing the edited video with a time node corresponding to the target video frame as a start playing node.

16. The electronic device of claim 12, wherein performing the single-frame processing on video frames of the target video input by the user based on the single-frame processing policy and caching the single-frame processing result to the single-frame processing list comprises:
receiving the target video input by the user, and decoding a video frame of the target video in real time, and obtaining a decoded video frame which has been decoded;
in response to that the decoded video frame does not meet a preset single-frame processing condition, returning to obtain a decoded video frame until all decoded video frames are obtained;
in response to that the decoded video frame meets the preset single-frame processing condition, inputting the decoded video frame to a single-frame processing model corresponding to the video editing option, and caching the single-frame processing result output by the single-frame processing model to the single-frame processing list; and
in the event that the single-frame processing list does not meet a video post-processing condition, returning to obtain a decoded video frame until all decoded video frames are obtained.

17. The non-transitory computer readable storage medium of claim 16, wherein the preset single-frame processing condition comprises:
a duration of an interval between an obtaining time point for obtaining the decoded video frame and a single-frame executing time point of a previous video frame of a video frame corresponding to the obtaining time point reaches a set duration; or
the decoded video frame meets a set frame format.

18. The non-transitory computer readable storage medium of claim 13, further comprising:
locating a video frame editing result corresponding to a target video frame based on the video editing sequence, and presenting an edited video, the target video frame being any video frame selected by the user from the target video within an editing interface.

19. The non-transitory computer readable storage medium of claim 18, wherein locating the video frame editing result corresponding to the target video frame based on the video editing sequence and presenting the edited video comprises:
monitoring a drag and drop operation of the user against a target video progress bar, determining a video timestamp corresponding to an end of the drag and drop operation;
determining a video frame corresponding to the video timestamp as the target video frame and accessing the video editing sequence; and
deserializing the video editing sequence to obtain a video frame editing result in the video editing sequence, and locating the target video editing result of the target video frame, and playing the edited video with a time node corresponding to the target video frame as a start playing node.

20. The non-transitory computer readable storage medium of claim 13, wherein performing the single-frame processing on video frames of the target video input by the user based on the single-frame processing policy and caching the single-frame processing result to the single-frame processing list comprises:
receiving the target video input by the user, and decoding a video frame of the target video in real time, and obtaining a decoded video frame which has been decoded;
in response to that the decoded video frame does not meet a preset single-frame processing condition, returning to obtain a decoded video frame until all decoded video frames are obtained;
in response to that the decoded video frame meets the preset single-frame processing condition, inputting the decoded video frame to a single-frame processing model corresponding to the video editing option, and caching the single-frame processing result output by the single-frame processing model to the single-frame processing list; and
in the event that the single-frame processing list does not meet a video post-processing condition, returning to obtain a decoded video frame until all decoded video frames are obtained.

21. The non-transitory computer readable storage medium of claim 20, wherein the preset single-frame processing condition comprises:
a duration of an interval between an obtaining time point for obtaining the decoded video frame and a single-frame executing time point of a previous video frame of a video frame corresponding to the obtaining time point reaches a set duration; or
the decoded video frame meets a set frame format.
